(19) United States
(12) Patent Application Publication
(10) Pub. No.: US 2003/0069076 A1
(43) Pub. Date: Apr. 10, 2003

(54) Damping transmission device for a motor

(76) Inventor: Jsai-Hsing Kao, Hsintien City (TW)

Correspondence Address: VENABLE, BAETJER, HOWARD AND CIVILETTI, LLP, P.O. BOX 34385, WASHINGTON, DC, 20043-9998, US

(21) Appl. No.: 09/970,906

(22) Filed: Oct. 5, 2001

(51) Int. Cl. F16C 3/00

(52) U.S. Cl. 464/180

(57) ABSTRACT

A damping transmission device for a motor has a transmission shaft by which a connection of gears can be driven by a motor. The transmission shaft has a ring and a washer mounted therearound. A spring is compressibly mounted around the transmission shaft, and mounted between the washer and the ring so as to absorb shock exerted onto the transmission shaft. The damping transmission device is able to provide a secure positioning and protect the motor from undesirable rotation.

### BACKGROUND OF THE INVENTION

1. Field of the Invention

The present invention relates to a transmission device, and more particularly to a damping transmission device for a motor such that the transmission device has a damping function to absorb shock to provide a secure positioning and prevent the motor from undesired rotation caused by the shock.

2. Description of the Related Art

Transmission devices are well known in the art to output power generated from a power supply such as a motor. A typical transmission device has a gear assembly connected to the motor. A shaft is also connected to the gear assembly so that the shaft is driven accordingly when the motor rotates. The shaft can be further connected to another device for moving or lifting an object. However, when the motor stops and the object is moved to a desired position, the weight of the object may cause the motor to undesirably rotate in a reverse direction thus gradually moving the object, especially when the object itself is not static. For example a modern jogging exerciser may have a jogging platform which can be adjusted to form a slope to simulate uphill jogging. In order to provide this function, the jogging exerciser has a motor connected to a transmission device. The transmission device is further arranged to be able to lift an end of the jogging platform upward so as to form the slope. When the transmission device raises the end of the jogging platform to a position and thereby allows the platform to form a desired slope, due to the dynamic impact cause by a user jogging on the platform, it will be difficult for the platform to maintain the desire slope. The raised end will gradually move downwardly to its original position. Moreover, this downward movement of the raised end will cause the motor driving the transmission device to rotate in a reverse direction with respect to the direction when raising the platform. The motor may be damaged when forced to rotate in the reverse direction.

To overcome the shortcomings, the present invention tends to provide a damping transmission device to mitigate or obviate the aforementioned problems.

### SUMMARY OF THE INVENTION

An objective of the present invention is to provide a damping transmission device for a motor such that the damping transmission device is able to absorb shock in order to provide secure positioning and protect the motor.

Other objectives, advantages and novel features of the invention will become more apparent from the following detailed description when taken in conjunction with the accompanying drawings.

### BRIEF DESCRIPTION OF THE DRAWINGS

FIG. 1 is an exploded, perspective view of a damping transmission device in accordance with the present invention;

FIG. 2 is a cross-sectional view of the damping transmission device;

FIG. 3 is a cross-sectional view of the damping transmission device when receiving an impact; and

FIG. 4 is another preferred embodiment of the damping transmission device.

### DETAILED DESCRIPTION OF THE PREFERRED EMBODIMENT

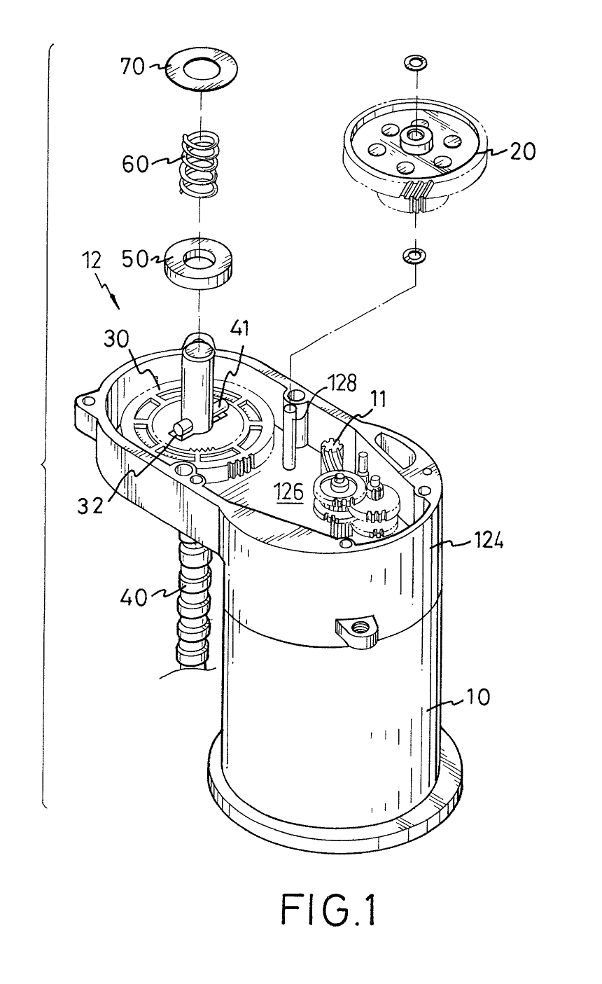

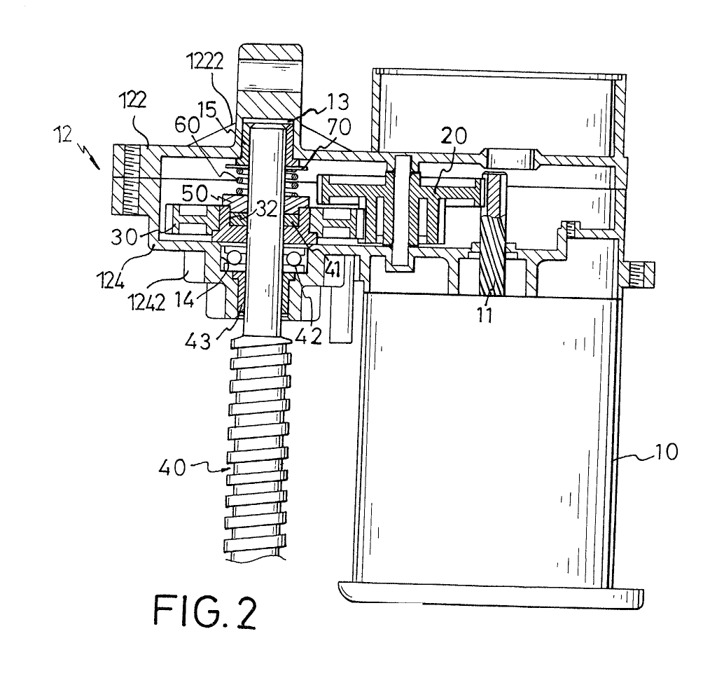

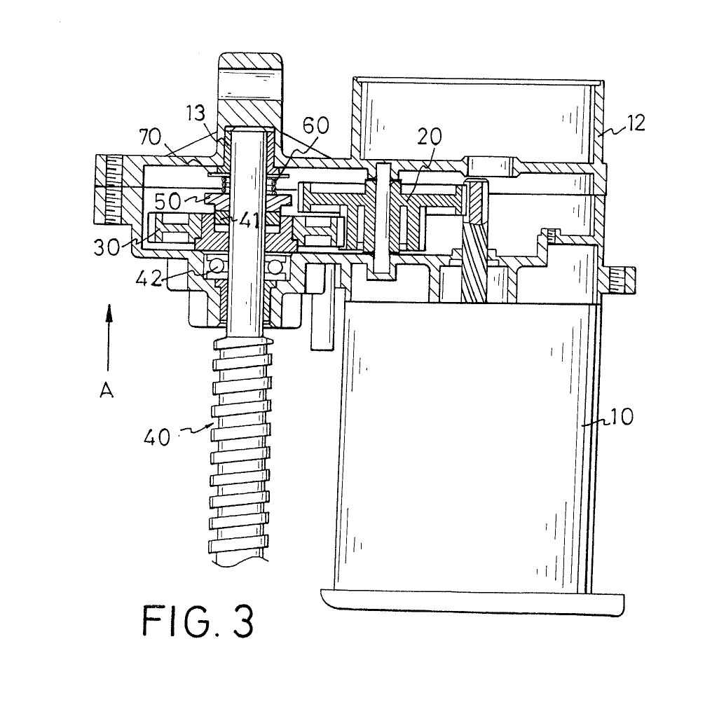

With reference to FIGS. 1 and 2, a damping transmission device for a motor (10) in accordance with the present invention has a housing (12) comprising a top piece (122) and a bottom piece (124). The housing (12) is hollow and has a chamber (126) defined therein. The motor (10) is assembled onto a side-portion of the bottom piece (124) and the motor (10) has a motor shaft (11) extending through the bottom piece (124) and into the chamber (126) of the housing (12). The bottom piece (124) has a bottom protruding portion (1242) juxtaposed with the motor (10). The bottom protruding portion (1242) has a bottom recess (14) defined therein. The top piece (122) has a top protruding portion (1222) formed on a side-portion of the top piece (122) corresponding to the bottom protruding portion (1242) of the bottom piece (124), and the top protruding portion (1222) has a top recess (13) defined therein. Both the top recess (13) and the bottom recess (14) communicate with the chamber (126). A transmission shaft (40) extends through the bottom piece (124), and into the bottom recess (14), chamber (126) and the top recess (13). An axle (128) is integrally formed on the bottom piece (124) and between the motor shaft (11) and the transmission shaft (40). A first gear (20) is disposed around the axle (128) so as to mesh with a serrated surface of the motor shaft (11). A second gear (30) having a socket (32) is disposed around the transmission shaft (40) and meshes with the first gear (20). A rod (41) transversely extends through the transmission shaft (40) and is received in the socket (32) so as to couple the second gear (30) and transmission shaft (40) together. As shown in FIGS. 2 and 3, a bottom sleeve (43) is disposed in the bottom recess (14) and around the transmission shaft (40), and a bearing (42) is disposed around the transmission shaft (40) and between the second gear (30) and the sleeve (43). Again referring to FIGS. 1 and 2, a ring (50) is disposed around the transmission shaft (40) and engages with the rod (41). A spring (60) is disposed around the transmission shaft (40) and a bottom end of the spring (60) abuts the ring (50). A top sleeve (15) is disposed inside the top recess (13) and a top end of the transmission shaft (40) moveably extends into the top sleeve (15). A washer (70) having a top surface (not numbered) and a bottom surface (not numbered) is disposed around the transmission shaft (40). The bottom surface of the washer (70) abuts with a top end of the spring (60) and the top surface engages with the top sleeve (15). Therefore, the spring (60) is sandwiched between the washer (70) and the ring (50) so that the spring (60) provides resilience to the ring (50) and pushes the ring (50) to restrict the rod (41) in the socket (32).

With reference to FIGS. 2 and 3, when operating, the motor shaft (11) rotates and drives the first gear (20) and the second gear (30) that are meshed together. The transmission shaft (40) that is coupled with the second gear (30) is driven accordingly. The shaft (40) can be further arranged to raise or move a load. If the load is not static, for example, a jogger as mentioned in the prior art, the load may cause impact or shock to the transmission shaft (40). As shown in FIG. 3, when the shock (A) moves the transmission shaft (40) upward, that is, moves the transmission shaft (40) to extend further into the top sleeve (15), the rod (41) pushes the ring (50) to move upwardly and compresses the spring (60). The compressed spring (60) can provide a resilience to absorb the shock that may otherwise cause the transmission shaft (40) to move and rotate undesirably. Therefore, the damping transmission device is able to provide a secure positioning to the load and prevent the motor (11) to rotate in a reverse direction which may damage the motor (11).

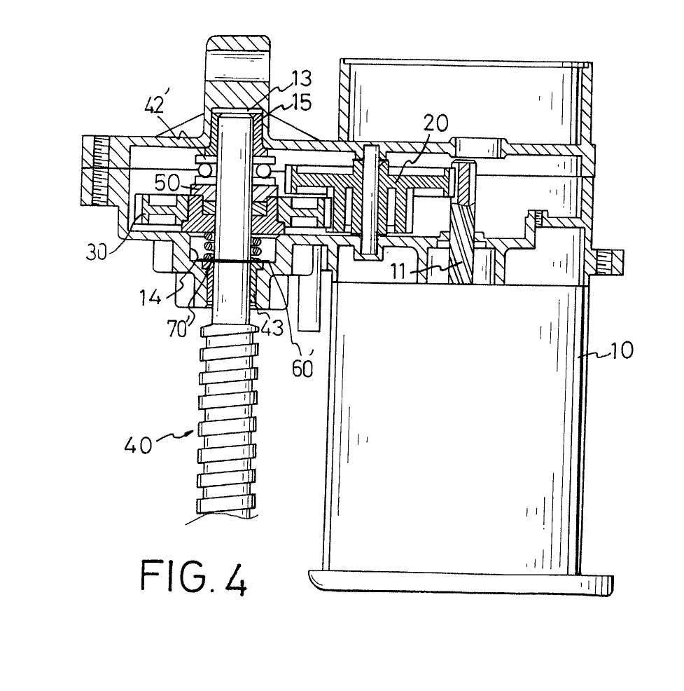

With reference to FIG. 4, another preferred embodiment of the damping transmission device is shown. In this preferred embodiment, a bearing (42′) is disposed around the transmission shaft (40) and between the top sleeve (15) and the ring (50) to replace the spring (60). The washer (70) of the previous embodiment is now disposed around the transmission shaft (40) and engages the bottom sleeve (43) as a washer (70′) in FIG. 4. Also a spring (60′) is disposed around the transmission shaft (40) and sandwiched between the washer (70′) and the second gear (30). Remaining parts of this preferred embodiment remain the same as the previous embodiment. Similar to the previous embodiment, the spring (60′) is able to be compressed to absorb shock caused by the load.

From the above description, it is noted that the invention has the following advantages:

1. Providing a secure positioning. When the transmission device is arranged to raise a load especially a dynamic load, shock caused by the load to the transmission will be absorbed by the spring (60, 60′) such that the transmission device is able to provide a secure positioning to the load.

2. Protect the motor (10). The shock caused by the load is absorbed by the spring (60, 60′) so that the motor (10), which is coupled to the transmission device, is prevented from undesirable rotation caused by the shock.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A damping transmission device for a motor having a motor shaft, the damping transmission device having:
a transmission shaft having an axial movement with respect to the motor and adapted to be driven by the motor shaft of the motor;
a ring securely mounted around the transmission shaft;
a washer mounted around the transmission shaft and on top of the ring; and
a damper compressibly mounted between the ring and the washer so as to absorb shock from the axial movement of the transmission shaft.

2. The damping transmission device as claimed in claim 1, wherein the transmission shaft further has a rod extending through opposed sides of the transmission shaft to support the ring.

3. The damping transmission device as claimed in claim 2, wherein the damper is a spring.

4. A damping transmission device for a motor having a motor shaft, the damping transmission device having:
a transmission shaft having an axial movement with respect to the motor and adapted to be driven by the motor shaft of the motor;
a ring securely mounted around the transmission shaft;
a washer mounted around the transmission shaft and under of the ring; and
a damper compressibly mounted between the ring and the washer so as to absorb shock from the axial movement of the transmission shaft.
